(19) United States
(12) Patent Application Publication
(10) Pub. No.: US 2011/0293388 A1
(43) Pub. Date: Dec. 1, 2011

(54) MAKING IT EASIER TO EXTRACT NAILS, AND OTHER BENEFITS

(76) Inventor: Barry Robert Hirschfeld, Beit Shemesh (IL)

(21) Appl. No.: 12/948,791

(22) Filed: Nov. 18, 2010

Related U.S. Application Data
(60) Provisional application No. 61/396,640, filed on Jun. 1, 2010.

(51) Int. Cl. F16B 15/00

(52) U.S. Cl. 411/439

(57) ABSTRACT

This patent application describes a kind of disc to be used when driving in a nail, the use of which makes it easier to extract the nail afterward. This disc comes in various shapes, a few of which use a specially shaped nail that is also described in this patent application.

The specifications and descriptions presented in this patent application are partially based on Provisional Patent 61/396640, dated on or about 1 Jun. 2010.

In this patent application the term ‘wood’ is used to designate any and all materials into which a nail has been driven or that a nail has been used to join.

In this patent application the term ‘nail collar’ is used to mean any of the discs described herein.

In this patent application the meaning of the term ‘wide-headed twinned nail’ is as described below in the fifth preferred embodiment.

This patent application proposes devices for making it easier to extract nails from wood, as well as providing other benefits that are presented in the Claims section.

Sometimes one wants to remove a nail from wood in order to reuse the wood, and also to cause either no damage, or as little damage as possible, to the wood during the extraction process. Or, less commonly, one wants to remove a nail from wood in order to reuse the nail and does not care about the wood, but does want the extraction process to be easy and simple.

The current tools for the extraction of nails, whether claw hammer or frame hammer or most other nail-extracting tools whether patented or not, usually rely on having the nail head resting upon the surface of the wood, as opposed to having the nail head driven into the wood.

But oftentimes, after the nail has been driven in, the nail head has yes been driven into the wood, which damages the surface of the wood. Using a screwdriver or other ‘handy’ tool to raise up such a driven-in nail head so as to then use a hammer claw or other nail-extracting tool, results in damage to the surface of, and possibly to the structure, of the wood, as well as possible damage to the screwdriver or other ‘handy’ tool. It would therefore be of benefit to find a means to prevent driving a nail head into the surface of the wood. The devices described in this patent application prevent driving a nail head into the surface of the wood, except for the one variation of this device where it is desired or required that the nail head yes be driven into the wood.

When a nail joins two or more pieces of wood, preliminary work may be required before the nail can be extracted. This work consists of prying the pieces of wood apart so as to partially extract the nail from the lower piece or pieces of wood, and then hammering down the upper piece of wood so as to expose the part of the shank of the nail that is next to the nail head. This work may take longer than the actual extraction of the nail. Furthermore, when using a hammer to pry apart the pieces of wood, the prying apart may cause damage to the wood, so that one may be forced to carry along an additional tool to do the prying without damaging the wood. It would therefore be of benefit to find a means of avoiding the tasks of prying apart and hammering down before extracting the nail. The devices described in this patent application eliminate the tasks of prying apart and hammering down before extracting the nail.

There exists a device for extracting a nail from wood, regardless of whether the nail head is on or below the surface of the wood; however, that device damages the surface and the structure of the wood. The devices described in this patent application do not damage the surface or the structure of the wood. And even when damage to the wood is acceptable, the devices described in this patent application are likely to cost far less to use than the device mentioned above that extracts a nail from wood regardless of whether the nail head is on or below the surface of the wood.

Double-headed nails are readily extracted and their extraction does not damage the surface of the wood. But double-headed nails are not suitable for general use due to the high-risk hazard of snagging. The devices described in this patent application do not present such a snagging hazard; on the contrary, they should help reduce the chances of snagging when used with a single-headed nail, as compared to a single-headed nail that does not use any of these devices.

The devices described in this patent application are, except for the outer edge, either flat discs, or in the third and fourth preferred embodiments described below the discs are not flat but instead the thickness of the disc varies linearly across the face of the disc so that the vertical cross-section of the disc is wedge-shaped except for the outer edge. In the second and fourth preferred embodiments of the discs described below, the disc has a radial cut extending from the disc's center to the disc's outer edge. A special wide-headed twinned nail, described below in the fifth preferred embodiment, is used with certain types of discs that are described below in the fifth and sixth preferred embodiments. The disc, whatever its shape, is either made with a hole in the center for the shank of the nail to go through, or the center of the disc is made without a hole but marked and the nail is pushed through there. Preferably, the disc has a slightly larger diameter than the nail head, so that nails with different head sizes use different disc sizes. Preferably, the disc has a raised outer edge round about with the edge tapering inward, so that the edge prevents the nail head from snagging after the nail has been driven in yet the raised edge is not so high as to noticeably interfere with the driving of the nail. The disc, whatever its shape, is also called a nail collar in this patent application.

The disc is placed, by way of its hole or by using the marking in its center, on the shank of the nail before the nail has been driven into anything, or for a disc having a cut extending from the disc's center to the disc's outer edge the disc is placed on the nail even after the nail has yes been partially driven into something. The placement of the disc on the nail may be done manually, mechanically, or a combination thereof, or the nail may be sold with the disc already in place.

In all variations of the nail collar, the thickness of the disc and the material of which it is made are such that, after the nail has been fully driven in, the nail collar keeps the nail head far enough above the surface of the wood so that the nail head can easily be caught by a hammer claw or other nail-extracting tool, and the nail collar readily gives way to said hammer claw or other nail-extracting tool for easy extraction of the nail.

The material of which this nail collar is made may be isotropic or anisotropic. It may be made of one piece, or it may be a fusion or a combination that is either mechanical or bonded, or of pieces of isotropic and/or anisotropic substances possibly having different physical properties and/or having different orientations. The manufacture of this nail collar, whatever its shape and material of construction, requires only equipment and knowledge that is obvious to practitioners of the art of manufacturing discs.

The first preferred embodiment is a disc of material, where the material is as described in the preceding paragraph, and where the disc has constant thickness except possibly at the edge, as described further on in this paragraph. Preferably, the disc has a slightly larger diameter than the nail head and the disc has a raised outer edge round about with the edge tapering inward, so that the edge prevents the nail head from snagging after the nail has been driven in yet the raised edge is not so high as to noticeably interfere with the driving of the nail. Preferably, this disc comes in several sizes for various sized nail heads, and where the several sizes have, for example, different colors or markings.

The second preferred embodiment is similar to the first, except that the disc has a radial cut from the disc's center to the disc's outer edge. This embodiment is useful where one has started to drive a nail and then remembers that a disc should have first been inserted: one can open the disc along the radial cut, snap it onto the nail shank, and continue to drive the nail. Preferably, this disc comes in several sizes for various sized nail heads, where the several sizes have, for example, different colors or markings, which are also different from those for the first preferred embodiment.

The third preferred embodiment is similar to the first, except that the thickness of the disc varies linearly across the face of the disc so that the vertical cross-section of the disc is wedge-shaped. Such a disc is useful when toenailing. Preferably, the disc has a slightly larger diameter than the nail head and the disc has a raised outer edge round about with the edge tapering inward, so that the edge prevents the nail head from snagging after the nail has been driven in yet the raised edge is not so high as to noticeably interfere with the driving of the nail. Preferably, this disc comes in several sizes and wedge angles for various sized nail heads, where the several sizes have, for example, different colors or markings.

The fourth preferred embodiment is similar to the third, except that the disc has a radial cut from the center hole to the outer edge. Such a disc is useful when one has forgotten to insert a disc when toenailing: one can open the disc along the radial cut, snap it onto the nail shank, and continue to drive the nail. Preferably, this disc comes in several sizes and wedge angles for various sized nail heads, where the several sizes have, for example, different colors or markings, which are also different from those for the third preferred embodiment.

It may be desired or be required that, after the nail is driven, the bottom of the head of the nail rest on, or be in contact with, the wood. In this fifth preferred embodiment, a specially shaped nail, which we call a ‘wide-headed twinned nail’, is used. This nail has a nail head and a shank, like all other nails. This first nail head is completely joined to a second nail head that is located immediately above it, where this second nail head has a sufficiently larger diameter than the first nail head so that the second nail head can be caught by a hammer claw or other nail-extracting tool. Preferably, the edge where the first and second nail heads meet should be rounded, to prevent excessive stress there. The disc used here is made of a material similar in physical properties to that described in the first preferred embodiment above. The disc is seated radially around the first nail head, the disc having the same axial thickness as the first nail head. The presence of this disc helps prevent driving the first nail head into the wood. Preferably, the disc has a slightly larger diameter than the second nail head, and has a raised edge round about to protect the second nail head from snagging after the nail has been driven in. To enable driving the nail without interference from the raised edge of the disc round about, the second nail head should preferably be slightly convex in shape and extend above the raised edge of this disc. To prevent use of the wide-headed twinned nail without the disc, which would be hazardous due to the risk of snagging, the wide-headed twinned nail should preferably be sold with the disc already in place. To help ensure that the disc cannot easily be removed from the nail, which would be hazardous due to the risk of snagging by the second nail head, the diameter of the first nail head can taper inward going toward the second nail head, during manufacture of the nail the disc can be either slipped over the first nail head or cast in place. The extraction starts by catching this second nail head with a hammer claw or other nail-extracting tool. Preferably, this disc and nail combination comes in several sizes for various sized nail heads, where the several sizes have, for example, different colors or markings. The manufacture of this wide-headed twinned nail requires only equipment and knowledge that is obvious to practitioners of the art of manufacturing nails.

It may be desired or be required that, after the nail is driven, the bottom of the head of the nail yes be driven into the surface of the wood. This sixth preferred embodiment is similar to the fifth preferred embodiment, including the use of a wide-headed twinned nail, except that the axial thickness of this disc is less than the axial thickness of the first nail head of the wide-headed twinned nail, where the amount that it is less is dependent on how far one wants the first nail head to be driven into the wood. Alternatively, one may increase the axial thickness of the first nail head instead of, or in addition to, decreasing the axial thickness of the disc. Preferably, this disc and nail combination comes in several sizes for various sized nail heads, where the several sizes have, for example, different colors or markings, which are also different from those for the fifth preferred embodiment.

Those skilled in the art will readily see that the discs of the first four preferred embodiments described above, and the disc and nail combinations of the fifth and sixth preferred embodiment described above, can be made in other obvious ways, shapes, and forms which are in essence non-substantial modifications to what has been described already in this patent application, and as such are included in this patent application.

1. Is a simple, inexpensive, and effective means of allowing a nail head to readily be caught and the extraction process to be started by hammer claws or other nail-extracting tools, thus saving the time and effort that would otherwise be needed to perform preliminary tasks such as raising the nail head up from or out of the piece of wood, prying apart pieces of wood, or hammering down pieces of wood, and saving the need to take along tools to perform said preliminary tasks, and avoiding the possibility of damaging tools that would otherwise be used to perform said preliminary tasks especially when the tools that might otherwise be used to perform said preliminary tasks are not suited for these preliminary tasks.

2. Decreases the chances of the nail head snagging a passing object after the nail head has been driven in, as compared to a nail head that does not use a nail collar.

3. Prevents the nail head from being driven into the wood, thereby decreasing the chances of surface damage or structural damage to the piece of wood; this claim is not made for the sixth preferred embodiment, which is used when it is desired or required that the nail head yes be driven into the wood.
